(19) United States
(12) Patent Application Publication
(10) Pub. No.: US 2010/0135035 A1
(43) Pub. Date: Jun. 3, 2010

(54) ADAPTIVE PROJECTOR SYSTEM FOR HEADLIGHTS OF MOTOR VEHICLES

(76) Inventors: Petr Smajser, Novy Jicin (CZ); Vladimir Petrovsky, Ostrava (CZ)

Correspondence Address: FRASER CLEMENS MARTIN & MILLER LLC, 28366 KENSINGTON LANE, PERRYSBURG, OH, 43551, US

(21) Appl. No.: 12/506,464

(22) Filed: Jul. 21, 2009

(30) Foreign Application Priority Data
Jul. 21, 2008 (CZ) PV 2008-452

(51) Int. Cl. B60Q 1/076

(52) U.S. Cl. 362/513

(57) ABSTRACT

An adaptive projector system for headlights of motor vehicles is disclosed, the system consists of a reflector with a light source, a lens (6) and a diaphragm system with fixed screening diaphragms, and with a movable approximately hyperboloid diaphragm cap, which rotates along with the shaft of a motor, on which it is firmly overhung, and by its controlled stopping in certain positions, it creates the desired light beams.

### CROSS-REFERENCE TO RELATED APPLICATION

This application claims the benefit of Czech Republic Pat. Appl. No. PV 2008-452 filed Jul. 21, 2008, hereby incorporated herein by reference in its entirety.

### FIELD OF THE INVENTION

The invention concerns an adaptive projector system for headlights of motor vehicles, designed to bring about changes in the spatial distribution of the light in front of the driver on the roadway by changing the position and profile of the diaphragm inside the projector light system as a result of projection, by the lens of this adaptive projector system, of the brightness contrast of the contour of this dark diaphragm on the light background of the reflector with light source.

### BACKGROUND OF THE INVENTION

To improve the safety of highway traffic, improvements are being made in the lighting produced by the headlights of a motor vehicle. The new regulation of the European Economic Commission ECE R123 makes it possible to apply totally new types of lighting for defined conditions, such as far beam lights, lights for city traffic, lights for rain, etc.

Multifunctional mechanisms for projector units able to achieve these different types of lighting from a single source are in development, close to production, or in production.

These changes in the type of lighting are for the most part achieved by rotation, displacement, or replacement of the light beam cutoff diaphragm.

An example of such a solution is the Hella “Varilis” patents (DE 102 16 678, DE 199 09 413 or EP 1 052 446 A2), the Valeo patents (FR 2 815 310 A2, U.S. Pat. No. 6,623,149 B2), the Koito patents (U.S. Pat. No. 5,339,226, U.S. Pat. No. 5,343,371), or Automotive Lighting.

The main drawbacks of these layouts are their excessive complexity, costliness, and slow operation.

### SUMMARY OF THE INVENTION

The above-mentioned drawbacks have been eliminated by the design of a simple adaptive projector system for the headlights of motor vehicles with direct drive from a step motor, or a dc motor with transmission.

According to this invention, an adaptive projector system has been developed for the headlights of motor vehicles, consisting of a reflector with light source, a diaphragm system, a lens and a mechanism for ensuring a change in the position of the diaphragm cap for different types of lighting and an electric motor driving this mechanism.

The rotationally movable part of the diaphragm system, or the diaphragm cap of hyperboloid shape, is firmly overhung (fastened one-sided) on the output shaft of the motor, whose axis is deflected from the transverse plane of the projector, where the transverse deflection (alpha) of the axis of rotation of the diaphragm cap is advantageously larger than the longitudinal deflection (beta) of the axis of the diaphragm cap from the horizontal plane, and the diaphragm cap is fixed at various defined positions of its rotation.

The drive for the diaphragm cap is advantageously realized by an electric motor, being a step motor or a dc motor with integrated transmission.

The fixed part of the diaphragm system is advantageously formed by a “cradle” consisting of a front fixed screening diaphragm and a rear fixed screening diaphragm, which extend roughly to the height of the axis of rotation of the diaphragm cap, the height of the rear fixed screening diaphragm being the same as or greater than the height of the front fixed screening diaphragm.

For precise stopping of the diaphragm cap in a defined position, it is advantageous to use a stop for the step motor or a comparator for the dc motor with integrated transmission.

The overhung mounting of the diaphragm cap on the motor shaft is preferably done on both sides of the motor, but at the edge of the diaphragm cap past the image-forming part.

The adaptive projector system for the headlights of motor vehicles thus encompasses a reflector, a light source, a lens and a diaphragm system, consisting of a fixed and a movable part and a mechanism for ensuring a change in position of the movable part of the diaphragm system by rotation thereof to achieve different types of light beams. The movable part of the diaphragm system is a lightweight diaphragm cap, approximately in the shape of part of a hyperboloid, able to turn with the motor shaft in an axis deflected from the transverse axis of the projector in both the transverse and the longitudinal plane. The diaphragm cap is overhung (fastened by its edge) on the motor shaft, and this fastening can occur on either one or both sides of the motor.

To screen out the passage of unwanted light beneath the diaphragm cap, one uses the fixed part of the diaphragm system, namely, the front and rear screening diaphragms, which together effectively screen out parasitic light penetrating beneath the diaphragm cap from all directions.

The purpose of this invention is to create a complex, yet simple and highly reliable mechanism of this kind.

### BRIEF DESCRIPTION OF THE DRAWINGS

The invention will be explained more closely hereafter with examples of its specific embodiments, which will be described with reference to the enclosed drawings, where for clarity, portions of the diaphragm mechanism in FIGS. 2 to 5 are drawn simplified in normal projection to the transverse plane of the headlight. The axis of the diaphragm mechanism is in fact inclined at the angle beta to the transverse plane in the case of a hyperboloid diaphragm.

FIG. 1 shows one possible embodiment of the projector unit, equipped with the described mechanism in a spatial view.

FIG. 2 shows the mechanism in front view, the diaphragm is turned by a (level) cropping of the fog light to the focal plane, the angle of inclination of the axis of rotation of the diaphragm cap from the horizontal is denoted alpha.

FIG. 3 shows in front view a variant with position sensor, the diaphragm is turned by its slot to the focal plane and lets through almost unscreened (far beam) light.

FIG. 4 shows in front view a variant with a stop for resetting the motor, the diaphragm is turned by the cropping of the dipped beam to the focal plane.

FIG. 5 shows in front view a variant with fastening of the edge of the diaphragm cap at both sides of the motor, the diaphragm is turned by the cropping of the dipped beam to the focal plane.

FIG. 6 shows the basic layout of the mechanism as a hyperboloid diaphragm cap whose axis of rotation is inclined toward the transverse plane.

FIG. 7 shows the layout of the mechanism in the projector unit in a special layout with conical diaphragm cap in top view.

FIG. 8 shows the layout of the diaphragm system—a rotary diaphragm cap and a “cradle” of fixed diaphragms in a section normal to the axis of rotation of the diaphragm cap.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner.

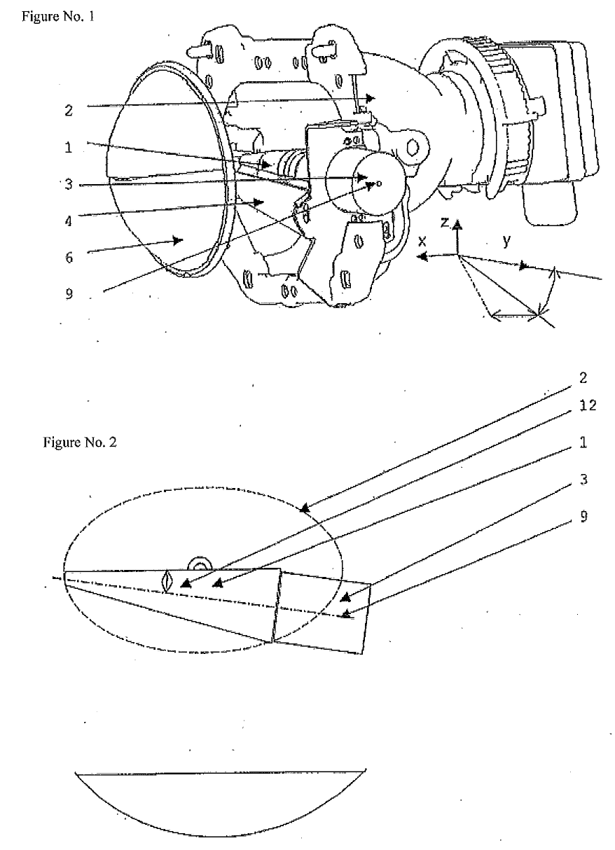

The adaptive projector system for the headlights of motor vehicles, installed in the projector unit of the headlights per FIG. 1, for which the most advantageous variant in terms of functionality and reliability is a diaphragm cap 1 which is in contact only with the shaft of the motor 3 (it is overhung on the shaft of the motor 3).

This embodiment is advantageous in terms of less complexity and defined friction, which can arise only in the bearings of the motor 3. This is contingent upon a quality design for the bearings of the motor 3 and low weight for the diaphragm cap 1.

The hyperboloid diaphragm cap 1 is provided with various slots and projections (see FIGS. 2, 3, 4, 5, 6 and 7), arranged similar to the teeth of hyperbolic gears, so that its rotation produces croppings of the respective light beams.

The diaphragm cap 1 thus rotates about the axis 9, which is deflected from the transverse axis of the headlight, and thus relative to the horizontal and transverse planes. It follows from the requirement for the best space utilization and optical function that the deflection of the axis 9 of rotation of the diaphragm cap 1 from the horizontal plane 12 (see FIG. 2) is generally larger than that from the transverse plane 13 (see FIG. 6).

It is advantageous to design the diaphragm cap 1 as merely a thin shell, except for its fastening site (see FIG. 8), which fulfills the optical function but otherwise has minimum weight and moment of inertia. This design of the diaphragm cap 1 can be made advantageously from pressed metal sheet or from special plastic.

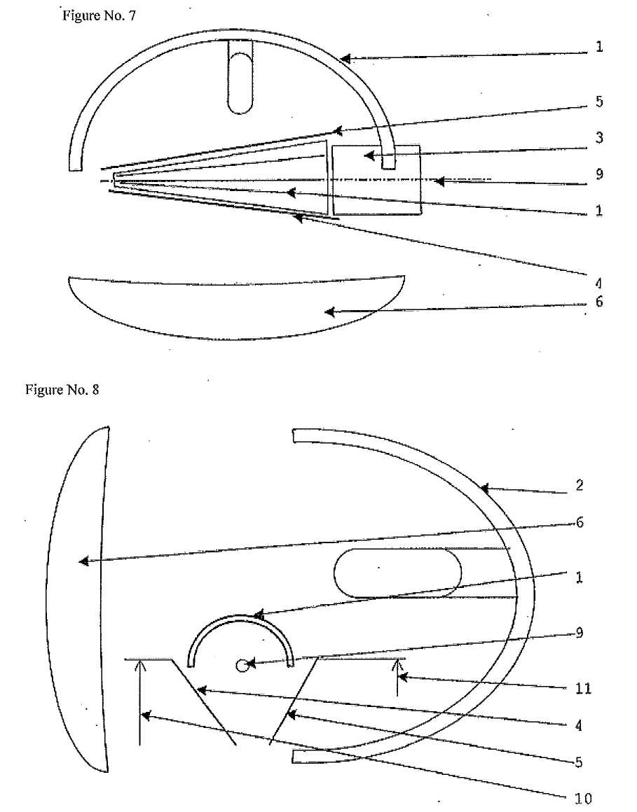

A special case is zero deflection of the axis from the transverse plane 13. Now the basic hyperboloid shape of the diaphragm cap 1 changes into a conical one (see FIG. 7). The simplification of the shape of the diaphragm cap 1 makes it necessary to remove the adjoining part of the reflector 2 in favor of the installation of the motor 3 and the fixed part of the diaphragm system, i.e., diaphragms 4 and 5.

The diaphragm system (see FIG. 8) fulfills the function of cropping the light beam and screening out of parasitic light to prevent an unwanted glare. This is made possible by a design wherein the height of the upper edge of the fixed screening diaphragms 4 and 5 is at every point roughly in the axis 9 of rotation of the diaphragm cap 1 and since somewhat more light penetrates to those places in the direction from above the upper part of the reflector 2, in the ideal case the height 11 of the rear fixed screening diaphragm 5 is equal to or somewhat greater than the height 10 of the front fixed screening diaphragm 4.

When using the almost level cropping edge of the diaphragm cap 1, see FIG. 2, an evenly trimmed light beam is produced, suitable, e.g., for fog lights, touring lights or city lights.

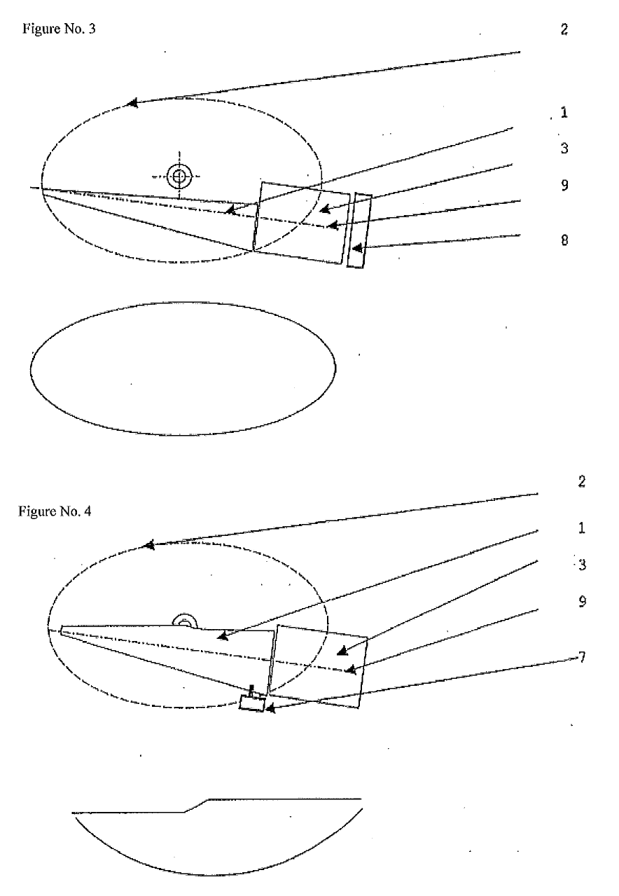

The maximum reduced part of the diaphragm cap I makes it possible to emit the far beams, see FIG. 3.

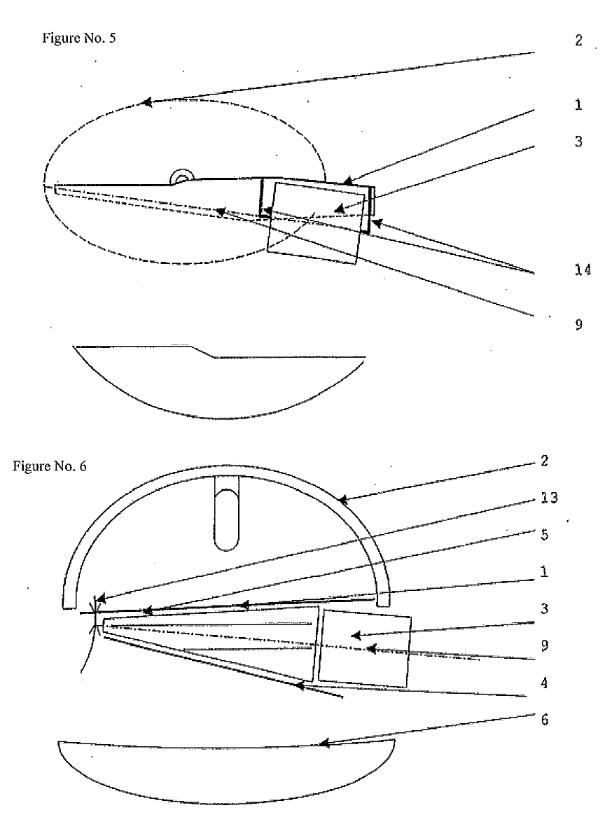

The Z-cropping of FIGS. 4 and 5 makes it possible to emit either European or British dipped beams depending on the orientation, i.e., different beams for right-handed or left-handed direction of driving.

In terms of quickness and simplicity, it is advantageous to rotate the diaphragm cap 1 directly by a multipole step motor 3. For greater precision and motor power, one can use a step motor or a dc motor with a transmission.

For driving by a step motor 3, the adaptive projector system will be provided with at least one stop 7 at the end of the range of working positions in order to reset the motor 3. Resetting of the motor 3 upon reaching the stop 7 is necessary to ensure a precise position, which otherwise can only be assured with an expensive position sensor.

If one uses a dc motor 3 with integrated transmission, it will be outfitted with a potentiometer (comparator 8), sensing the position of the diaphragm cap 1. This will ensure a precise position for the diaphragm cap 1 and its lighting function at each moment of operation.

One benefit of the design is its substantial simplicity (the diaphragm cap 1 simply rotating on the shaft of the motor 3) for an absolute complexity of design (on the surface of the diaphragm cap 1 it is possible to place large numbers of practically arbitrary croppers of the light beam). The mechanism is optically and functionally optimized in terms of construction, the diaphragm cap 1 turns about a generally spatially oriented axis 9 of rotation.

From the foregoing description, one ordinarily skilled in the art can easily ascertain the essential characteristics of this invention and, without departing from the spirit and scope thereof, can make various changes and modifications to the invention to adapt it to various usages and conditions.

### LIST OF REFERENCE NUMBERS

1 diaphragm cap
2 reflector 2 with light source
3 electric motor
4 front fixed screening diaphragm
5 rear fixed screening diaphragm
6 lens 6 of projector unit
7 stop 7 for reset of step motor
8 comparator 8 for determining position of do motor
9 axis 9 of rotation of electric motor shaft
10 height 10 of front fixed screening diaphragm
11 height 11 of rear fixed screening diaphragm
12 angle of deflection of axis of rotation from longitudinal plane
13 angle of deflection of axis of rotation from transverse plane
14 variant of fastening at both sides of motor

What is claimed is:

1. An adaptive projector system for headlights of motor vehicles comprising:
a reflector with light source for emitting a light beam;
a diaphragm cap spaced from the reflector and at least partially disposed in the light beam;
a lens for receiving and transmitting the light beam after passing the diaphragm cap;
an electric motor for rotationally driving the diaphragm cap, wherein different rotational positions of the diaphragm cap produce different types of lighting patterns for the light beam transmitted by the lens.

2. The adaptive projector system according to claim 1, wherein the diaphragm cap has a substantially hyperboloid shape.

3. The adaptive projector system according to claim 1, wherein the diaphragm cap is overhung on an end of an output shaft of the motor.

4. The adaptive projector system according to claim 1, wherein an axis of rotation of the diaphragm cap is deflected from a transverse plane of the projector and a horizontal plane of the projector, and wherein the transverse deflection is larger than the horizontal deflection.

5. The adaptive projector system according to claim 1, wherein the electric motor is a step motor.

6. The adaptive projector system according to claim 1, wherein the electric motor is a dc motor.

7. The adaptive projector system according to claim 1, wherein the diaphragm cap is part of a diaphragm system with a front fixed screening diaphragm and a rear fixed screening diaphragm which extend substantially to a height of an axis of rotation of the diaphragm cap, the height of the rear fixed screening diaphragm being at least the height of the front fixed screening diaphragm.

8. The adaptive projector system according to claim 1, further comprising a stop for precise stopping of the diaphragm cap in a defined position.
